(19) United States
(12) Patent Application Publication
(10) Pub. No.: US 2008/0277044 A1
(43) Pub. Date: Nov. 13, 2008

(54) Kit for repairing and inflating inflatable articles, and relative control method

(75) Inventor: Maurizio MARINI, Pesaro (IT)

Correspondence Address: LADAS & PARRY LLP, 26 WEST 61ST STREET, NEW YORK, NY, 10023, US

(73) Assignee: TEK GLOBAL S.R.L.

(21) Appl. No.: 12/152,134

(22) Filed: May 12, 2008

(30) Foreign Application Priority Data
May 11, 2007 (IT) TO2007A000323

(51) Int. Cl. F04D 29/00; B29C 73/02

(52) U.S. Cl. 156/97; 417/313

(57) ABSTRACT

A kit for repairing and inflating inflatable articles, comprises an electric compressor unit; a container of sealing fluid connectable to the compressor unit; a plug for connecting the compressor unit to a power outlet; electronic control means connected to the plug and to the compressor unit; and an electronic switch connected to the electronic control means and for transmitting a control signal to activate the compressor unit. In particular, the electronic control means is designed to only activate the compressor unit when the control signal is received after a power signal transmitted when the plug is connected to the power outlet.

The present invention relates to a kit for repairing and inflating inflatable articles, preferably vehicle tyres.

### BACKGROUND OF THE INVENTION

Kits are known comprising an electric compressor unit connectable to a power outlet on the vehicle; a container of sealing fluid connectable fluidically to the compressor unit; and a hose normally connected to the container and connectable to the tyre.

A kit of this sort is stowed on the vehicle and used when necessary to either repair a tyre, using the container of sealing fluid, or to adjust the pressure of the tyres when the hose is connected directly to the compressor unit.

A flat tyre invariably results in a certain amount of panic on the part of the driver and passengers of the vehicle, and may occur at night in a poorly lit area, thus making it difficult to repair. It is therefore preferable that the kit be easy to use even in these conditions.

It is also preferable that the kit be equipped with safety devices to avoid improper use which might impair correct operation of the kit.

More specifically, kits are known in which the electric compressor unit is turned on by a mechanical on-off toggle switch. At times, either due to careless handling when stowing the kit on the vehicle, or to inexperience of the user, the switch may inadvertently be set to the “on” position before the compressor unit is connected to the power outlet on the vehicle. When this occurs and the compressor unit is connected to the power outlet, the electric motor comes on immediately, and, if the hose is not yet connected to the tyre, the sealing fluid is dispensed outside the tyre, and the amount left, when the switch is turned off by the user, may not be enough to repair the tyre. When the kit is used for inflation only, the compressed air issuing from the hose not fixed to the valve of the inflatable article causes snaking of the hose, thus endangering the user.

### SUMMARY OF THE INVENTION

It is an object of the present invention to provide a kit for repairing and inflating inflatable articles, designed to eliminate the aforementioned drawbacks.

According to the present invention, there is provided a kit for repairing and inflating inflatable articles, as claimed in the attached Claims.

### BRIEF DESCRIPTION OF THE DRAWINGS

A preferred, non-limiting embodiment of the present invention will be described by way of example with reference to the accompanying drawings, in which:

FIG. 1 shows a view in perspective, with parts removed for clarity, of a kit in accordance with the present invention;

FIG. 2 shows a rear view of the FIG. 1 kit;

FIG. 3 shows a flow chart of a method of controlling the FIG. 1 kit.

### DETAILED DESCRIPTION OF THE INVENTION

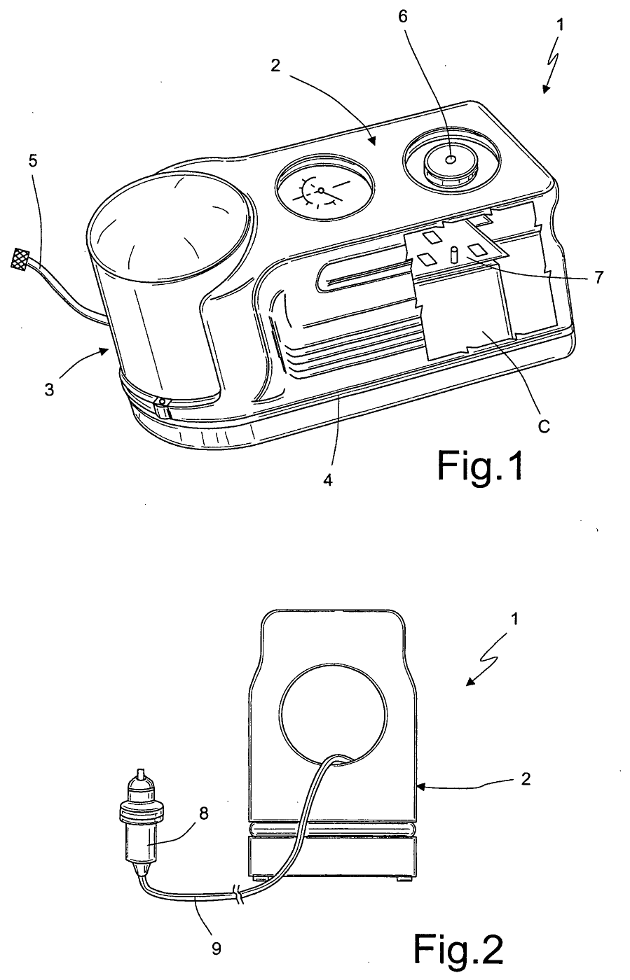

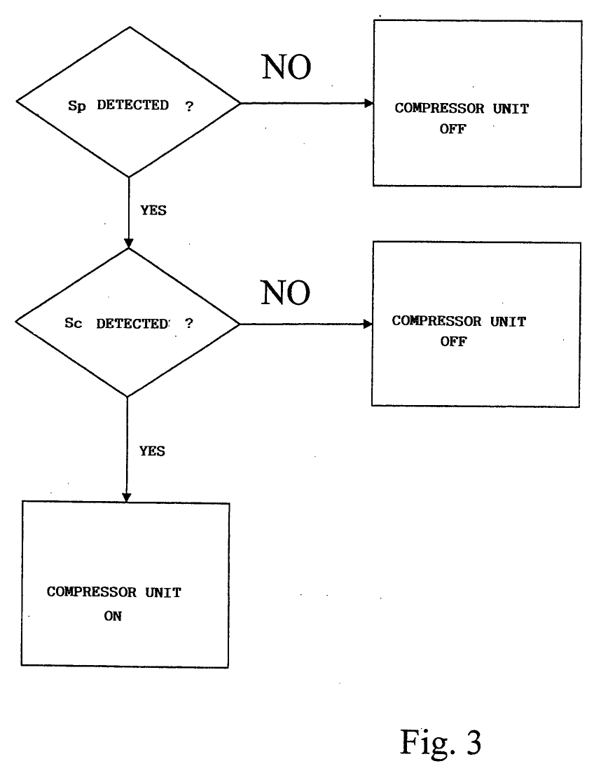

Number 1 in FIG. 1 indicates as a whole a kit for repairing and inflating inflatable articles, and comprising a casing 2; a compressor unit C housed inside casing 2; a container 3 of sealing fluid; and a hose 4 connected to container 3.

Compressor unit C conveniently comprises in known manner an electric motor, and a compressor controlled by the electric motor to produce and blow compressed air into container 3.

More specifically, container 3 is connected fluidically to compressor unit C by a fluidic line (not shown) housed inside casing 2, and is preferably as described and illustrated in Patent Application WO-A-2005084968 filed by the present Applicant.

Kit 1 preferably comprises a second hose 5 connected directly to compressor unit C, in parallel with hose 4, for non-repair inflation purposes, as described in detail in Patent Application WO-A-WO2005085028 filed by the present Applicant.

Kit 1 also comprises an electronic switch 6 on casing 2; an electronic control board 7 connected to electronic switch 6; and a plug 8 connected to electronic control board 7 by an electric lead 9 to power compressor unit C (FIG. 2).

More specifically, electronic control board 7 receives both a power signal Sp defined by the supply voltage of compressor unit C and transmitted when plug 8 is connected to the power outlet, and a control signal Sc transmitted when electronic switch 6 is pressed to activate compressor unit C.

Power signal Sp is preferably defined by a 5 V voltage, and corresponds to the supply voltage of compressor unit C. The power signal Sp powering electronic control board 7 is conveniently transformed by a known transformation device from the supply voltage of the plug 8 power outlet. For example, in the case of an on-vehicle power outlet, the voltage supply is 12V, and transformation is from 12V to 5V.

Electronic control board 7 is powered by power signal Sp, and only when board 7 is powered can control signal Sc be sent by electronic switch 6.

When control board 7 is not powered, control signal Sc cannot be sent by electronic switch 6, and no means are provided to memorize signal Sc when control board 7 is not powered.

In actual use, when plug 8 is connected to the power outlet, compressor unit C is therefore only turned on after electronic switch 6 is pressed, and electronic control board 7 has processed control signal Sc. If plug 8 is disconnected while compressor unit C is running, e.g. by inadvertently pulling on the lead of plug 8, no trace remains of control signal Sc, and no signal can be sent by electronic switch 6, even if it is pressed, on account of the signal being neither generated nor transmitted in the absence of power by power signal Sp. Compressor unit C is therefore only turned on after plug 8 is plugged back into the power outlet, and electronic switch 6 is pressed again.

The advantages of a kit for repairing and inflating inflatable articles in accordance with the present invention are as follows.

Electronic switch 6 connected to electronic board 7 implements a control procedure which enhances the safety, while in no way complicating use, of kit 1, and in particular prevents compressor unit C from being turned on the instant plug 8 is plugged into the power outlet.

Clearly, changes may be made to the kit for repairing and inflating inflatable articles, as described and illustrated herein, without, however, departing from the scope of the present invention as defined in the accompanying Claims.

1) A kit for repairing and inflating inflatable articles, comprising an electric compressor unit (C); a container (3) of sealing fluid connectable to said compressor unit; and a plug (8) for connecting said compressor unit (C) to a power outlet; and characterized by comprising electronic control means (7) connected to said plug (8) and to said compressor unit (C); and an electronic switch (6) connected to said electronic control means (7) and for transmitting a control signal (Sc) to activate said compressor unit (C); said electronic control means (7) being designed to only enable said electronic switch (6) to transmit said control signal (Sc) after receiving a power signal (Sp) transmitted when said plug (8) is connected to said power outlet.

2) A kit as claimed in claim 1, characterized in that said electronic control means (7) are designed not to memorize said control signal (Sc) when said power signal (Sp) is cut off and said plug (8) is disconnected from said power outlet.

3) A kit as claimed in claim 1, characterized in that said power signal (Sp) is defined by a supply voltage of said compressor unit (C).

4) A control method for electronic control means (7) of a kit (1) for repairing and inflating inflatable articles as claimed in claim 1, characterized by comprising the steps of:
receiving said power signal (Sp) from said plug (8);
only enabling said electronic switch (6) to transmit a control signal (Sc) to activate said compressor unit (C) after receiving said power signal (Sp).
